(19) United States
(12) Patent Application Publication
(10) Pub. No.: US 2009/0121131 A1
(43) Pub. Date: May 14, 2009

(54) Method of determination of resolution of scanning electron microscope

(76) Inventor: Arkady Nikitin, Yonkers, NY (US)

Correspondence Address: Ilya Zborovsky, 6 Schoolhouse Way, Dix Hills, NY, 11746, US

(21) Appl. No.: 11/983,622

(22) Filed: Nov. 13, 2007

(51) Int. Cl. G01N 23/00

(52) U.S. Cl. 250/307

(57) ABSTRACT

A method of determining a resolution of a scanning electron microscope includes using an image of an object provided by the scanning electron microscope during scanning of an object of measurement, obtaining information about a resolution of the scanning electron microscope from the image of the object during its scanning by the scanning electron microscope; and using the information for determining the resolution of the scanning electron microscope.

### BACKGROUND OF THE INVENTION

Scanning electron microscopes are widely used in the industry and science research. In the areas where such microscopes are used for obtaining quantitative information, it is important to know the resolution of the scanning electron microscope. A measure of resolution can be Gauss radius σ of primary electrons which scan the object.

The resolution is usually determined by a company-manufacturer of the microscope in accordance with a special method and introduced into a passport of the device among its most important characteristics. In practice often it is not sufficient. The resolution of the scanning electron microscope is not a constant value, but instead it changes with the process of operation and depends on many factors, in particular on accuracy of setting and adjustment of the microscope. Quality of the adjustment of a scanning electron microscope, in turn, is determined by a qualification of the operator. The resolution changes with changes of accelerating voltage and current of the primary beam, value of a working distance, accuracy of focusing of the scanning electron microscope image, and nature and properties of an object to be scanned. The multiplicity of the factors which influence the resolution, in particular the fact that some of them are connected with a subjective skills of operator, leads to situation that the passport resolution practically never coincides with a factual resolution, and can be used only as orientation for corresponding evaluation. However, in order to obtain the accurate quantitative data from the scanning electron microscope images, for example for measurements of a “critical dimension” in microelectronics, it is necessary to know the factual resolution of the critical dimension scanning electron microscope [1] at the moment of scanning of the objects to be measured, and not its value which was obtained in a different time and in different conditions and introduced into the passport of the device.

Several methods for determination of resolution of scanning electron microscope are proposed in [2-4]. In the proposed methods it is recommended to use special test samples (for example island films of gold on a carbon film) and special methods of conducting the measurements. This procedure is spaced in time from the process of measurements of the sizes. In order to realize this procedure it is necessary to replace the object to be measured with a special measure, or in other words to carry out the displacement of the objects in a chamber of the microscope, to provide a repeated focusing of the images, to compensate changes of working distances, or in other words, to perform intervention into the mode of operation of the microscope. This inevitably leads to a non-coincidence of the resolution attested in this manner with the factual resolution which pertains to the measuring microscope at the moment of carrying out the measurement of sizes. Therefore the monitoring of the resolution performed in this way is not efficient.

However, it is possible to use the influence of resolution on the structure of the scanning electron microscope image and on the quantitative information derived from.

### SUMMARY OF THE INVENTION

Accordingly, it is an object of the present invention to provide a method of determination of resolution of scanning electron microscopes, which is a further improvement of the existing methods.

In keeping with these objects and with others which will become apparent hereinafter, one feature of the present invention resides, briefly stated, in a method of determining a resolution of a scanning electron microscope, comprising the steps of using an image of an object provided by the scanning electron microscope during scanning of an object of measurement; obtaining information about a resolution of the scanning electron microscope from the image of the object during its scanning by the scanning electron microscope; and using the information for determining the resolution of the scanning electron microscope.

When the method of determining a resolution is performed in accordance with the present invention, it is significantly more accurate than the existing methods.

In accordance with another feature of the present invention, a method is proposed which includes the steps of selecting two points on a video profile including a point corresponding to a maximum of a videosignal, and another point; selecting on the image obtained by the scanning electron microscope an element which is a test-object, in accordance with which a resolution will be determined; from a video image obtained by the scanning electron microscope selecting a line which corresponds to a dependency of a signal S from a coordinate u along a line of scanning, which is an experimental video profile S(u); localizing said points on the video profile with their coordinates X1 and X2; calculating a difference of coordinates of DEL=|X2−X1| wherein DEL is a constant obtained without presuppositions or conditions; with the use of a preliminarily information about an object to be measured and the scanning electron microscope, forming a set of parameters describing the object of scanning in characteristics of the scanning electron microscope which forms a file of input data; assigning to the parameters plausible numerical values and using them during calculations of a videosignal in accordance with a model; with the use of a mathematical model calculating a set of model video signals S_{M}(u) for various values of resolution in accordance with the formula

$${S}_{M} ( u ) \approx {\int }_{- ∞}^{∞} K ( {u}^{′} ) * exp \{ - \frac{{( u - {u}^{′} )}^{2}}{{σ}^{2}} \} d {u}^{′}$$

wherein K(u′) is a function of an object or dependency of a local, pointed coefficient of a secondary electron emission K from coordinate u′ along the line of scanning on the object σ—is a Gauss of a radius of an electronic beam which scans the object; on each calculated model video signal, localizing characteristic points including a point of a maximum videosignal P1 and another point P2 with the coordinates X1 and X2 correspondingly; calculating a difference of the coordinates D=|X2−X1| in accordance with the calculated model videosignal, wherein the coordinates and their difference depend on the resolution σ: D(σ)=|X2(σ)−X1(σ)|, so that a set of values D which depends on the resolution σ is a calibrating dependency during determination of the resolution σ; in accordance with the value of DEL and the calibrating dependency D(σ), determining a factual resolution of the scanning electron microscope image is determined in a moment when it is obtained.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a flowchart of a method of determination of resolution of scanning electron microscopes in accordance with the present invention;

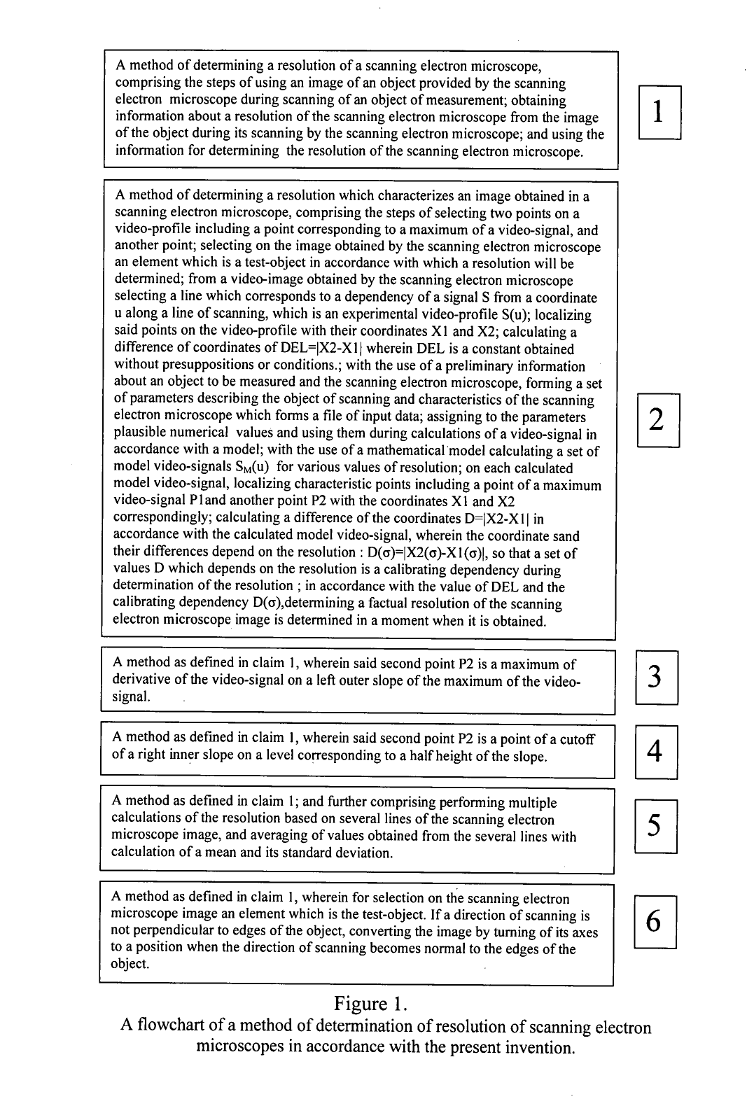

FIG. 2 is a view showing a geometry of an object to be measured, a shape of a video signal or its video profile, with positions of corresponding points used in the inventive method; and

FIG. 3 is a view substantially corresponding to the view of FIG. 2, but showing another embodiment of the present invention;

FIG. 4 is the calibrating dependency D(σ).

### DESCRIPTION OF THE PREFERRED EMBODIMENTS

In accordance with the present invention, a method is proposed determining a resolution of a scanning electron microscope, that comprises the steps of using an image of an object provided by the scanning electron microscope during scanning of an object of measurement; obtaining information about a resolution of the scanning electron microscope from the image of the object during its scanning by the scanning electron microscope; and using the information for determining the resolution of the scanning electron microscope.

The method in accordance with the present invention utilizes an influence of resolution on a structure of a scanning electron microscope image and on a quantitative information which can be derived from it.

The presence of this influence can make a conclusion that in any scanning electron microscope image factually there is an information about a resolution, which is realized during scanning of an object to be measured. This information can be derived from the images of the object to be measured in accordance with the present invention. In the inventive method of measurements of resolution of scanning electron microscope (or radius σ of beam of electrons scanning an object) the above mentioned concept that in any scanning electron microscope image factually there is an information about a resolution is utilized. Therefore, several variants of obtaining of this information from the existing scanning electron microscope image can be proposed. This variants can be different with regard to accuracy of results, labor and complexity of calculations. The common feature of the proposed is a wide use of mathematical models of forming of a video signal in the scanning electron microscope. These models can include models for calculation of a video signal in accordance with Monte Carlo (5, 6). Preferable are analytical models, for example a model described in (7), and calculations in accordance with this model do not require significant computing resources and time.

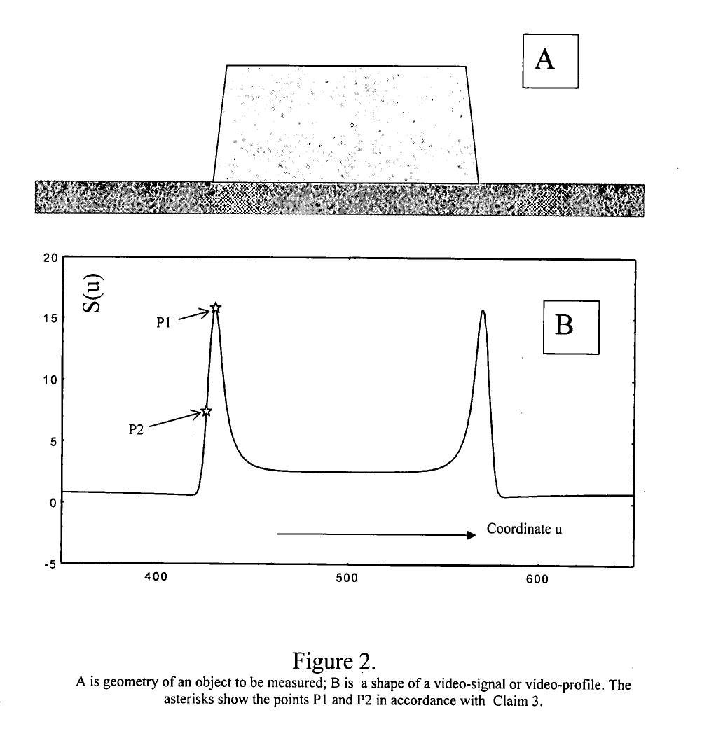

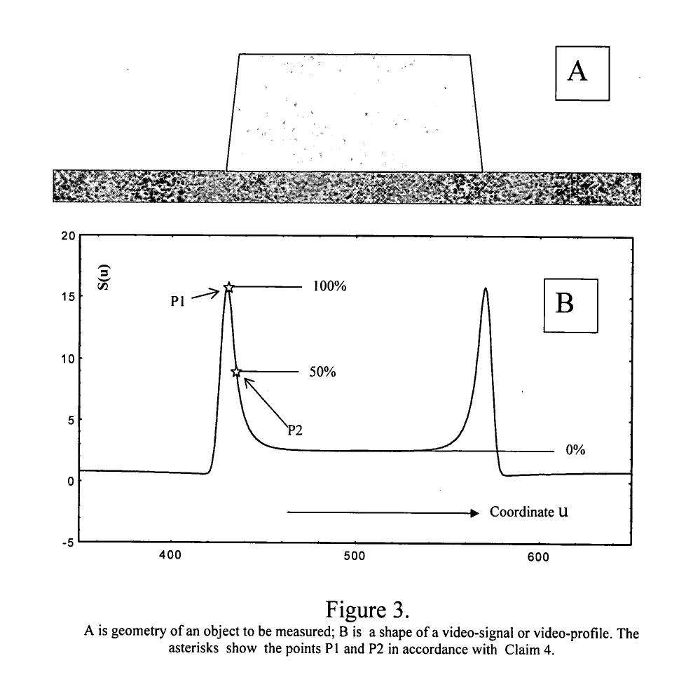

The method in accordance with the present invention includes the following steps. First of all on a video profile a pair of points is selected, whose position depends on a focusing. These points can be points corresponding to a maximum of video signal P1 and corresponding a maximum of its derivative on a left (outer) slope of the maximum point P2 as shown in FIG. 2. In accordance with another embodiment, the first point P1 is a point corresponding to a maximum of the video signal, while the second point P2 is a point corresponding to a cutoff of a right (inner) slope in accordance with a level equal to a half height of this slope in accordance with the embodiment shown in FIG. 3.

Then on the scanning electron microscope image an element or test-object is selected, in accordance with which a resolution will be determined. If the direction of scanning is not perpendicular to edges of the selected object, then preliminarily the scanning electron microscope image is converted by turning of its axes to a position when the direction of the scanning becomes perpendicular to the edges of the selected element.

From the scanning electron microscope image of the object obtained during a standard procedure of scanning, a line is selected which represents a dependence of a signal S from a coordinate u along the line of scanning on the image-experimental video profile S (u).

For making an evaluation of a resolution, it is necessary to select and measure such specifics of the video signal, which satisfy some requirements in the best way. These requirements include high sensitivity to changes of resolution, stability to noises of video signal, unambiguousness of determination of the resolution. In the present application as these features, distances between the special points of the video signal P1 and P2 shown in FIGS. 2 and 3 are selected. As explained herein above, the point P1 is an X-coordinate of the maximum of the video signal on an edge of a shaped element, while the point P2 is either an X-coordinate of a maximum of derivative on the left (outer) slope of the video signal as shown in FIG. 2, or an X-coordinate of intersection of an inner, right slope of the same maximum by the level of cut-off or threshold 50% as shown in FIG. 3.

After this selection of the points P1 and P2, their coordinates X1 and X2 are determined, and a difference of the coordinates DEL=|X2−X1| is calculated. The value of DEL is an objective characteristic of a video signal, obtained from an experiment without any presumptions or conditions.

For the calculation of model videosignals it is necessary first of all to determine a set of parameters which characterize the object of scanning, selected as a test element, and also characteristics of the scanning electron microscope or in other words a file of input data. This file includes characteristics of the test object: its composition, presence of a relief, its depth, angles of inclination of side walls, presence of closely located relief details, distance to them, and also parameters characterizing the microscope: accelerating voltage, magnification. Based on the available information about the test object and measuring microscope, numerical values are assigned to these parameters, and they are used for calculation of the videosignal in accordance with the model.

In accordance with the accepted approach to calculation of model video signals, first with the use of the information from the file of input data, a so-called “function of object” K(u′) is calculated, or in other words a dependency of local, pointed coefficient of a secondary electronic emission K from coordinate u′ along the line of scanning on the object. The function of the object can be considered as a hypothetical videosignal which can be realized under the condition that the Gauss radius of electronic probe σ is equal to zero.

In a second stage of calculations, a model videosignal itself is computed or a video profile S (u), or in other words the dependency of the value of video signal S from the coordinate u along the direction of scanning in the scanning electron microscope image: (on a screen of a monitor or on a picture). The calculation of S (u) is performed in accordance with the following formula:

$$S ( u ) \approx {\int }_{- ∞}^{∞} {K ( u )}^{′} * exp \{ - \frac{{( u - {u}^{′} )}^{2}}{{σ}^{2}} \} d {u}^{′} . \qquad ( 1 )$$

In the mathematical sense, the expression (1) is a convolution K(u′) with the Gauss exponents having a width σ. It should be mentioned that the parameters of the input file are used only during the calculations of K(u). During subsequent calculations of the videosignal S(u) for different values σ, the function of the object K(u′) is used as non changeable and its second calculation is not needed, of course if the file of the input data has not changed.

Then, calculations of the video signal in accordance with the above presented formula are carried out at different values of σ. A range of changes of σ is not important for the operability of the method and can be selected by a user. However, it must embrace all presuposed values of the microscope. The number of variants of individual values σ is usually not very high (it is recommended to have not more 5-7), since the dependencies which are of interest for the present invention are monotonous and close to linear.

Then, on each of the selected model videoprofiles which differ by resolution σ, a localization of two characteristic points is performed: maximum of the videosignal or the point P1, and a point P2 which can be either a maximum of derivative of the videosignal as shown in FIG. 2 or an intersection of an inner slope of this maximum with a threshold 50% as shown in FIG. 3. Since the position of the points P1 and P2 depends on σ, therefore for calculation of model video signals a difference D(σ)=|X2(σ)−X1(σ)| also depends on the resolution σ.

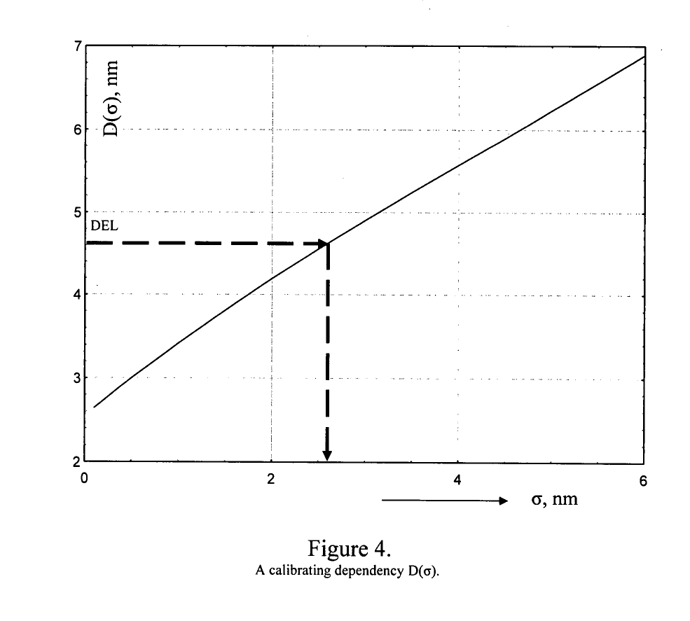

The set of values D(σ) obtained in this way is a calibrating dependency. Using this dependency and the constant DEL obtained before, it is easy to determine a factual resolution of the scanning electron microscope image σ shown in FIG. 4.

When a geometry of the object changes, it is necessary to introduce changes into the set of input parameters of the model, and again recalculation of a function of the object K(u′), the videosignal S(u) and the calibrating dependency DEL(σ) must be performed.

In the present method the values of σ depend on presence and level of noises of the video signal. Noise peaks at high amplitude can distort the position of maximum of the videosignal, and even more the position of the maximum of its derivative.

It is therefore recommended to carry out independent determination of resolution in over several lines of the scanning electron microscope image and to average individual measurements with a calculation of their mean value and dispersion.

It will be understood that each of the elements described above, or two or more together, may also find a useful application in other types of method differing from the type described above.

While the invention has been illustrated and described as embodied in a method of determination of resolution of scanning electron microscope, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of determining a resolution of a scanning electron microscope, comprising the steps of using an image of an object provided by the scanning electron microscope during scanning of an object of measurement; obtaining information about a resolution of the scanning electron microscope from the image of the object during its scanning by the scanning electron microscope; and using the information for determining the resolution of the scanning electron microscope.

2. A method of determining a resolution which characterizes an image obtained in a scanning electron microscope, comprising the steps of selecting two points on a video profile including a point corresponding to a maximum of a videosignal, and another point; selecting on the image obtained by the scanning electron microscope an element which is a test-object, in accordance with which a resolution will be determined; from a video image obtained by the scanning electron microscope selecting a line which corresponds to a dependency of a signal S from a coordinate u along a line of scanning, which is an experimental video profile S(u); localizing said points on the video profile with their coordinates X1 and X2; calculating a difference of coordinates of DEL=|X2−X1| wherein DEL is a constant obtained without presuppositions or conditions; with the use of a preliminarily information about an object to be measured and the scanning electron microscope, forming a set of parameters describing the object of scanning in characteristics of the scanning electron microscope which forms a file of input data; assigning to the parameters plausible numerical values and using them during calculations of a videosignal in accordance with a model; with the use of a mathematical model calculating a set of model video signals S_{M}(u) for various values of resolution in accordance with the formula
$${S}_{M} ( u ) \approx {\int }_{- ∞}^{∞} K ( {u}^{′} ) * exp \{ - \frac{{( u - {u}^{′} )}^{2}}{{σ}^{2}} \} d {u}^{′}$$
wherein K(u′) is a function of an object or dependency of a local, pointed coefficient of a secondary electron emission K from coordinate u′ along the line of scanning on the object σ—is a Gauss of a radius of an electronic beam which scans the object; on each calculated model video signal, localizing characteristic points including a point of a maximum videosignal P1 and another point P2 with the coordinates X1 and X2 correspondingly; calculating a difference of the coordinates D=|X2−X1| in accordance with the calculated model videosignal, wherein the coordinates and their difference depend on the resolution σ:D(σ)|X2(σ)−X1(σ)|, so that a set of values D which depends on the resolution σ is a calibrating dependency during determination of the resolution σ; in accordance with the value of DEL and the calibrating dependency D(σ), determining a factual resolution of the scanning electron microscope image is determined in a moment when it is obtained.

3. A method as defined in claim 1, wherein said second point P2 is a maximum of derivative of the video signal on a left outer slope of the maximum of the video signal.

4. A method as defined in claim 1, wherein said second point P2 is a point of a cutoff of a right inner slope on a level corresponding to a half height of the slope.

5. A method as defined in claim 1; and further comprising performing multiple calculations of the resolution based on several lines of the scanning electron microscope image, and averaging of values obtained from the several lines with calculation of a mean and its standard deviation.

6. A method as defined in claim 1, wherein for selection on the scanning electron microscope image an element which is the test object, if a direction of scanning is not perpendicular to edges of the object, converting the scanning electron microscope image by turning of its axes to a position when the direction of scanning becomes normal to the edges of the object.
